(19) United States
(12) Patent Application Publication
(10) Pub. No.: US 2011/0283900 A1
(43) Pub. Date: Nov. 24, 2011

(54) Trash Compactor Bin Components and Methods

(75) Inventors: Bob Fritz, Glendale, CA (US); Van Doaran, Long Beach, CA (US)

(73) Assignee: MAG Aerospace Industries, Inc., Carson, CA (US)

(21) Appl. No.: 13/094,413

(22) Filed: Apr. 26, 2011

Related U.S. Application Data
(60) Provisional application No. 61/343,276, filed on Apr. 26, 2010.

(51) Int. Cl. B30B 15/00

(52) U.S. Cl. 100/102; 100/255; 100/35

(57) ABSTRACT

Embodiments of the present invention relate generally to cylindrical trash compaction units that allow for application of increased compaction forces.

This application claims the benefit of U.S. Provisional Application Ser. No. 61/343,276, filed Apr. 26, 2010 titled “Cylindrical Bin for Trash Compactor,” the entire contents of which are hereby incorporated by reference.

### FIELD OF THE INVENTION

Embodiments of the present invention relate generally to cylindrical trash compaction units that allow for application of increased compaction forces.

### BACKGROUND

Collecting and disposing of trash in confined conditions, particularly on-board passenger transport vehicles, such as aircraft, trains, ships, buses, RVs, and other water or air travel vessels can be challenging. However, a good deal of rubbish is generated on such vehicles. For example, after in-flight beverage service, unused items are collected, which often includes drink cups, napkins, newspapers, food wrappers, tea bags, beverage cans, other packaging or non-consumable items and the like, food wastes, or any other type of disposable item that a passenger may consume or bring on-board.

First, it is desirable to compact trash and other unused items so that the materials collectively take up less space in the galley area. Second, it is desirable that the trash compactor unit be appropriately sized and as efficient as possible. Third, it is further desirable that the trash compactor be as light as possible, particularly if intended for use on board a passenger aircraft. During the compaction cycle, the downward force of the trash contents is transferred through the trash and must be contained by the surrounding structure. Until now, most trash compactors have used rectangular bins and chambers for the trash. This is likely because rectangles are relatively easy to design and manufacture, and trash containment boxes or bins are fairly easy to build in a rectangular shape. One example of a commonly-used trash carton in a rectangular shape is shown in FIG. 4. One example of a rectangular bin positioned inside a rectangular trash compactor is shown in FIG. 5.

Although rectangular systems do work for their intended purpose, and are expected to continue to be used in for food service/trash compaction activities on board passenger transport vehicles in the future, the present inventors have realized that an alternate, cylindrical structure may provide additional and enhanced weight and space efficiency benefits. Although cylindrical trash vessels have been used in some instances, there remain many opportunities for improvements for their use in connection with trash compactors for use on-board passenger transport vehicles.

### BRIEF SUMMARY

Embodiments of the present invention provide a trash compactor, comprising a cylindrical compaction chamber configured to receive and contain waste, and a cylindrical compaction bin configured to receive and contain the cylindrical compaction chamber, the cylindrical compaction bin comprising at least one hinge and at least one securing feature. During a compaction cycle, the at least one securing feature maintains the cylindrical compaction bin in a closed position, and upon completion of a compaction cycle, the at least one securing feature is released to allow opening of the cylindrical compaction bin along the at least one hinge for removal of the cylindrical compaction chamber. The embodiments described herein are particularly useful on-board passenger transport vehicles, such as passenger aircraft.

### BRIEF DESCRIPTION OF THE DRAWINGS

FIG. 1 shows a side perspective view of one embodiment of a cylindrical compaction chamber.

FIG. 2 shows a side perspective view of one embodiment of a trash compactor unit.

FIG. 3 shows a comparison of forces applied to a cylindrical trash compactor container as opposed to a rectangular trash compactor container.

FIG. 4 shows a prior art rectangular carton.

FIG. 5 shows the rectangular carton of FIG. 4 positioned in a trash compactor unit.

### DETAILED DESCRIPTION

The present inventors have determined that replacing the rectangular compaction chamber with a cylindrical one can offer better space and weight efficiency. A higher compaction force may be used, since the outward forces can be restrained easier in a cylindrical container under “hoop stresses,” rather than the forces restrained on flat “plates” in the rectangular design. A weight savings is realized because the strength-to-weight ratio of the cylinder is greater than that of the rectangle. Although cylindrical chambers, when fitted into the same space as a rectangular box, have less volume, a greater compaction force may be used.

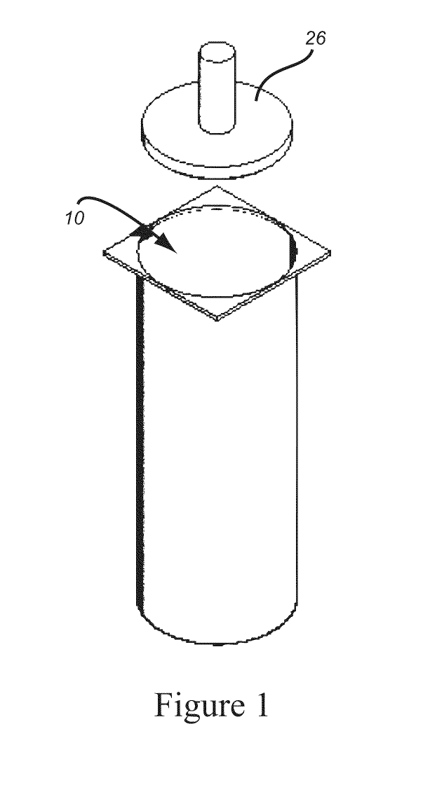

FIG. 1 shows one example of a cylindrical compaction chamber 10 designed for use in connection with a trash compactor. For perspective, chamber 10 is designed to fit inside a cylindrical compaction bin, described in more detail below. As used throughout this application, the term “cylindrical” is intended to mean having a generally circular or round circumference or a tubular shape. A perfect cylinder is not required and it should be understood that various manufacturing processes may prevent chambers from being considered a perfect cylinder, but can still be considered “cylindrical” within the meanings described herein.

Chamber 10 is configured to receive and contain waste. It may be manufactured from a cardboard material, a flexible plastic material, or any other appropriate material that can withstand a compaction force while maintaining its shape, and still be light enough for easy removal from the trash compactor. Chamber 10 may be lined or coated with a waterproof or water resistant material, or it may contain a separate internal, lightweight liner (e.g., a garbage bag) to prevent liquid spillage.

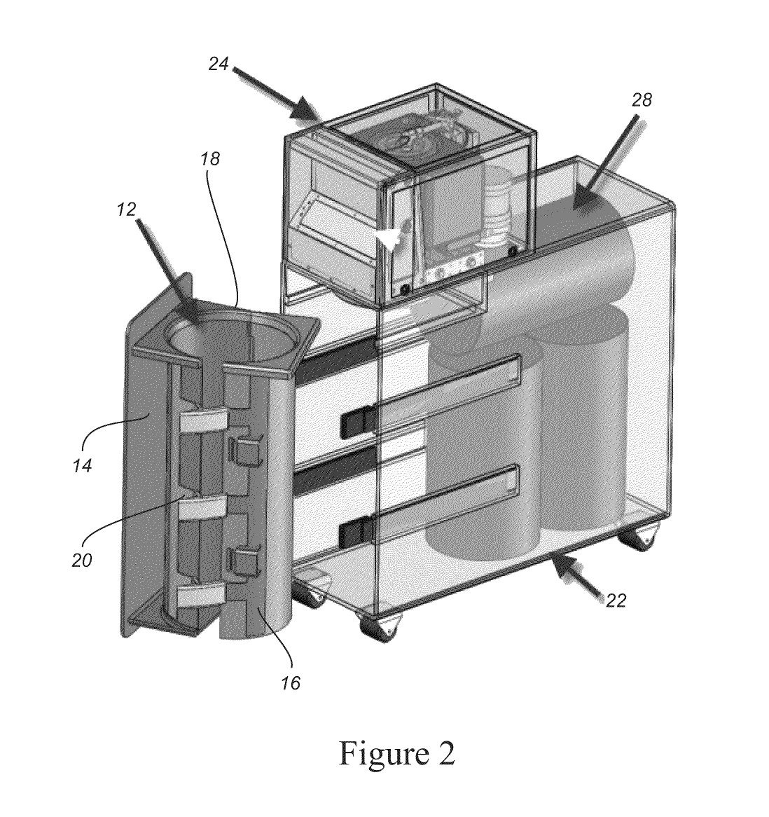

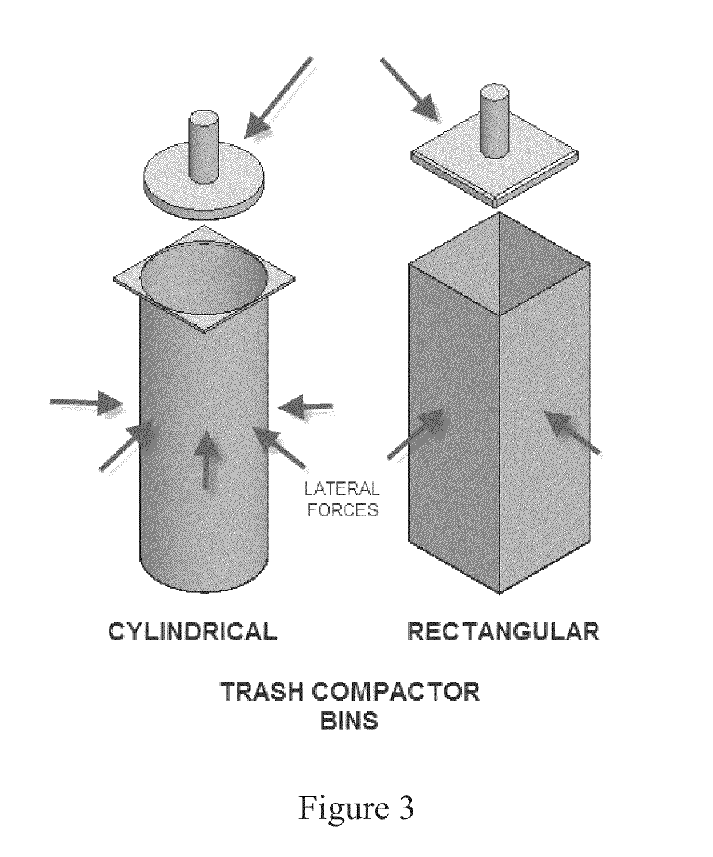

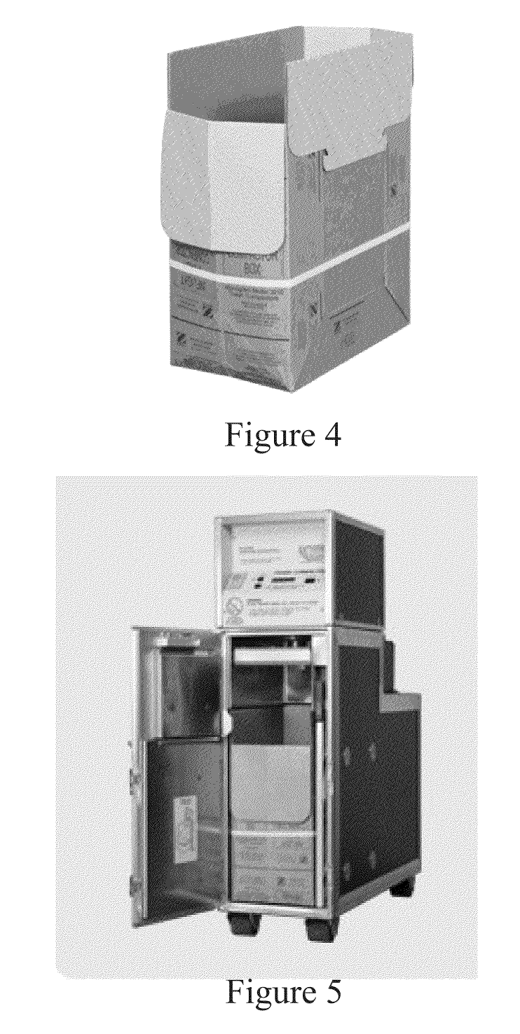

In use, cylindrical compaction chamber 10 is designed to fit within a cylindrical compaction bin 12. In the embodiment shown in FIG. 2, cylindrical compaction bin 12 comprises two halves 14, 16 that are connected by at least one hinge 18. Hinge 18 may extend the full length of the halves, or there may be one small hinge, or there may be a plurality of hinges provided. The general concept is that cylindrical compaction bin 12 is capable of being opened along the at least one hinge 18 and securely closed via at least one securing feature. During a compaction cycle, the at least one securing feature maintains the cylindrical compaction bin in a closed position, and upon completion of a compaction cycle, the at least one securing feature is released to allow opening of the cylindrical compaction bin along the at least one hinge for removal of the cylindrical compaction chamber.

Outer edges of halves of the cylindrical compaction bin 12 are provided with at least one portion of a cooperating securing feature 20. Securing feature may be a clasp, hook, snap, twist knobs, C-clips, or any other securing feature that can be opened and closed (preferably without tools), but maintain halves together under a compressive compaction force.

As shown in FIG. 2, the cylindrical compaction bin 12 is positioned within a trash compactor unit 22. Unit 22 may be secured in an aircraft galley (or other vehicle galley) or it may be a trolley or cart intended for mobile use on-board the aircraft or other vehicle. Unit 22 may instead be located in the aircraft galley, lavatory, or any other appropriate position where trash may be collected and need to be compacted. Bin 12 may be removably positioned and securable in unit 22. Above bin is a plunger force generator 24. Various plunger force generators and their manufacture and mechanics are generally known in the art. One distinguishing feature of note is that the plunger 26 (also referred to as a platen) is circular and is designed to closely approximate, but be slightly smaller than, an inner circumference of the cylindrical compaction chamber 10.

Unit 22 is also provided with stowage space 28 for housing one or more cylindrical compaction chambers 10, either before or after filled with trash and compacted. Although stowage space 28 may simply be an empty space at the back of unit 22, it may also contain shelves or supports for the chambers.

During use, an attendant obtains a cylindrical compaction chamber 10 and positions it in the cylindrical compaction bin 12. S/he secures the cylindrical compaction bin 12 in a closed position by activating the at least one securing feature 20. The trash compactor is now ready for loading. During in-flight service and as items are collected, trash may be loaded into the cylindrical compaction chamber 10. Once the chamber is loaded to a certain capacity, a trash compaction cycle is activated. This process may take place a few times, until the chamber has been filled to capacity. The attendant will then release the at least one securing feature 20 to open the cylindrical compaction bin 12 along the at least one hinge 18 to allow removal of the cylindrical compaction chamber 10 containing the compacted trash items.

The used cylindrical compaction chamber 10 may then be stored in the stowage space 28 in unit 22, and a new cylindrical compaction chamber 10 may be obtained and positioned in the bin 12.

Changes and modifications, additions and deletions may be made to the structures and methods recited above and shown in the drawings without departing from the scope or spirit of the invention and the following claims.

What is claimed is:

1. A trash compactor, comprising:
(a) a cylindrical compaction chamber configured to receive and contain waste; and
(b) a cylindrical compaction bin configured to receive and contain the cylindrical compaction chamber, the cylindrical compaction bin comprising at least one hinge and at least one securing feature.

2. The trash compactor of claim 1, wherein during a compaction cycle, the at least one securing feature maintains the cylindrical compaction bin in a closed position, and upon completion of a compaction cycle, the at least one securing feature is released to allow opening of the cylindrical compaction bin along the at least one hinge for removal of the cylindrical compaction chamber.

3. The trash compactor of claim 1, wherein the cylindrical compaction chamber comprises a cardboard liner or a plastic liner.

4. The trash compactor of claim 1, further comprising a circular platen designed to closely approximate but be slightly smaller than an inner circumference of the cylindrical compaction chamber.

5. The trash compactor of claim 1, wherein the trash compactor is mounted on a cart comprising stowage for one or more additional cylindrical compaction chambers.

6. The trash compactor of claim 1, wherein the trash compactor is mounted in an aircraft galley.

7. The trash compactor of claim 1, wherein the trash compactor is located on-board a passenger transport vehicle.

8. A trash stowage and compaction cart for use on-board a passenger transport vehicle, comprising:
(a) one or more cylindrical compaction chambers configured to receive and contain waste;
(b) a cylindrical compaction bin configured to receive and contain one cylindrical compaction chamber at a time, the cylindrical compaction bin comprising at least one hinge and at least one securing feature, wherein during a compaction cycle, the at least one securing feature maintains the cylindrical compaction bin in a closed position, and upon completion of a compaction cycle, the at least one securing feature is released to allow opening of the cylindrical compaction bin along the at least one hinge for removal of the cylindrical compaction chamber and replacement of a new cylindrical compaction chamber;
(c) a plunge force generator comprising a circular platen designed to closely approximate but be slightly smaller than an inner circumference of the cylindrical compaction chamber; and
(d) stowage space for one or more additional cylindrical compaction chambers.

9. The cart of claim 8, wherein the cart is located on-board a passenger aircraft.

10. A method for compacting trash on-board a passenger transport vehicle, comprising:
(a) obtaining one or more cylindrical compaction chambers configured to receive and contain waste;
(b) positioning one of the cylindrical compaction chambers in a cylindrical compaction bin, the cylindrical compaction bin comprising at least one hinge and at least one securing feature,
(c) securing the cylindrical compaction bin in a closed position by activating the at least one securing feature;
(d) putting one or more trash items in the cylindrical compaction chamber;
(e) activating one or more trash compaction cycles; and
(f) releasing the at least one securing feature to open the cylindrical compaction bin along the at least one hinge to allow removal of the cylindrical compaction chamber containing compacted trash items.

11. The method of claim 10, further comprising (g) stowing the cylindrical compaction chamber containing compacted trash items in a stowage space.

12. The method of claim 10, wherein the passenger transport vehicle is a passenger aircraft.
